(19) United States
(12) Patent Application Publication
(10) Pub. No.: US 2012/0105645 A1
(43) Pub. Date: May 3, 2012

(54) ULTRASONIC IMAGING WITH A VARIABLE REFRACTIVE LENS

(75) Inventors: Michael R. Burcher, Cambridge (GB); Yan S. Shi, White Plains, NY (US); Jean-Luc Robert, White Plains, NY (US)

(73) Assignee: KONINKLIJKE PHILIPS ELECTRONICS N.V., EINDHOVEN (NL)

(21) Appl. No.: 13/201,245

(22) PCT Filed: Feb. 16, 2010
(86) PCT No.: PCT/IB2010/050690

§ 371 Date: Jan. 17, 2012

Related U.S. Application Data
(60) Provisional application No. 61/154,140, filed on Feb. 20, 2009.

(51) Int. Cl. G06K 9/00

(52) U.S. Cl. 348/163; 348/E05.085

(57) ABSTRACT

The present invention relates to a method for producing an ultrasound image with a variable refractive lens (6) by transmitting a plurality of transmit beams (Tx1-Tx4) from an array of transducers (5) and receiving echo signals with the array of transducers (5) through the variable refractive lens (6) with an associated lens shape. By combining echo signals of receive lines from different transmit beams which are spatially related, the invention enable producing an image using image data. The invention is beneficial for high frequency ultrasonic imaging with the transducers being relatively larger sized than hitherto needed for high frequency applications. The array of transducers does not need to be “well-sampled”; i.e. having the width or size being comparably to the center wavelength of the ultrasonic signals to be received. This is particularly important at very high frequencies where well-sampled arrays would require very small elements that would be very challenging to manufacture.

### FIELD OF THE INVENTION

The invention relates to a method for producing an ultrasound image with a variable refractive lens.

The invention further relates to an imaging system comprising a variable refractive lens arranged for producing an ultrasound image and to a computer program product being adapted to enable a computer system comprising at least one computer having data storage means associated therewith to control such imaging system.

### BACKGROUND OF THE INVENTION

Conventional ultrasound is performed by using an array of elements to focus and steer ultrasound beams in a pulse-echo fashion. The signals received by the array are beamformed by delaying and summing them. By applying different delays to the same received data, multiple receive beams can be formed for a single transmit event. Systems today typically use 2 or 4 receive beams (or multi-lines) to increase frame rates.

Fluid focus technology has been proposed for use in ultrasound imaging. A Fluid focus lens can be constructed from two immiscible liquids with differing sound speeds. Refraction occurs at the interface between the liquids and this can be used to focus or steer the ultrasound beam. When a voltage is applied between the liquid and the enclosure, electrowetting causes the meniscus to move. This allows the focal depth and inclination of the interface to be controlled by varying the voltage. Fluid focus technology accordingly provides a very flexible variable refractive lens with numerous applications in various kind of imaging, e.g. optical and ultrasonic imaging.

Fluid focus technology is particularly suited for high frequency applications requiring small apertures (gravitational effects are problematic with larger lenses). Examples of this include intra-cardiac imaging with a catheter-based probe.

For intra-cardiac imaging (and especially lesion monitoring) extremely high axial resolution and hence ultrasound frequencies are required. A typical center frequency would be 25 MHz. This corresponds to a wavelength • of 62 μm. To construct a conventional phased array requires an element pitch of •/2=31 μm, which is an extreme challenge from a technical point of view. The fluid focus technology offers a nice solution—it allows the beam to be coarse steered to form the image, but a high frequency single-element transducer can still be used. Unfortunately the fluid focus lens is only capable of being steering in a single direction at a time due to the fixed focus, so no receive multi-line is possible. In addition it is not possible to carry out dynamic receive focusing (whereby the receive focus is moved deeper as the line is received). The resulting images therefore have a fixed focus in both transmit and receive and this limits their resolution away from the focus. Hence, an improved method for producing an ultrasound image with a variable refractive lens would be advantageous, and in particular a more efficient and/or reliable method for such use would be advantageous.

### SUMMARY OF THE INVENTION

Accordingly, the invention preferably seeks to mitigate, alleviate or eliminate one or more of the above mentioned disadvantages singly or in any combination. In particular, it may be seen as an object of the present invention to provide a method for producing an ultrasound image with a variable refractive lens that solves the above mentioned problems of the prior art with the need for relatively small transducers for high frequency ultrasonic applications.

This object and several other objects are obtained in a first aspect of the invention by providing a method for producing an ultrasound image with a variable refractive lens, comprising:

transmitting a plurality of transmit beams from an array of transducers, each transmit beam being centered at a different position along the array and each transmit beam encompassing a plurality of laterally spaced line positions which are spatially related to laterally spaced line positions of another beam, each transit beam being transmitted through the variable refractive lens with an associated lens shape;

receiving echo signals with the array of transducers, each echo signal being received through the variable refractive lens with an associated lens shape;

producing a plurality of receive lines of echo signals at the laterally spaced line positions of the receive beam by

1) concurrently processing the echo signals received in response to one transmit beam; or
2) or repeatedly transmitting transmit events corresponding to the same transmit beam and for each receiving echo signals from a different direction

repeating producing a plurality of receive lines of echo signals for additional transmit beams;

combining echo signals of receive lines from different transmit beams which are spatially related to produce image data; and

producing an image using the image data.

The invention is particularly, but not exclusively, advantageous for providing a method for high frequency ultrasonic imaging with the transducers being larger sized than hitherto needed for high frequency applications. The array of transducers does not need to be “well-sampled”; i.e. having the width or size being comparably to the center wavelength of the ultrasonic signals to be received. This is particularly important at very high frequencies where well-sampled arrays would require very small elements that would be very challenging to manufacture.

When repeatedly transmitting transmit beams and receiving echo signals from different directions to produce a plurality of receive lines of echo signals at the laterally spaced line positions of the beam, i.e. when obtaining the echo signal in a sequential manner, it may be possible to implement the processing in a comparably simple manner.

In one embodiment, at least a sub-group of transducers, in the said array of transducers, may have a width, W, significantly larger than half the center wavelength of the transmit pulses. In particular, the width, W, may be at least 5, 10, 15 or 20 times larger than half the center wavelength of the transmit pulses. The present invention thereby enables simplified hardware implementation of transducers for ultrasonic imaging, preferably at high frequencies. In a special embodiment, all of the transducers in the array, i.e. not just a subgroup, may have a width, W, significantly larger than half the center wavelength of the transmit pulses.

In a particular embodiment, the minimum number of transducers in the said array, N_elements, may be given by the inequality;

N_elements=D/W>(N_transmits−1)/2*1/(M_{—}sa,gla)

where

D is the transmit aperture,

W is the width of each transducer at least in a sub-group of the transducers,

N_transmits is the number of transmits from which spatially related echo signals are combined, and

M_sa,gla is the maximum accepted relationship between steering angle and grating lobe angle of the refractive lens and the array of transducers.

From these parameters it is accordingly possible to arrive at a minimum number of transducers in the array for advantageous implementation of the present invention. It should be noted that the width of each transducer, W, may be higher than hitherto seen, especially for high frequencies of transmits.

Typically, the number of transducers in the array, N_elements, may be above 5, 10, 15 or 20. Preferably, the transmit beam may be ultrasonic high frequency pulses, preferably with center frequency of at least 10 MHz, 20 MHz, 25 MHz, 30 MHz, 40 MHz or 50 MHz.

Optionally, at least a sub-group of transducers, in the said array of transducers, may have a width, W, above 0.1, 0.2 or 0.3 mm. Typically, the transducers have almost same shape and size, but it is also not the case.

Typically, the maximum accepted relationship between steering angle and grating lobe angle, M, of the refractive lens and the array of transducers may be in the interval of approximately 5-40%, preferably 10-35%, more preferably 15-25% depending on the specific choice of design for the ultrasonic imaging.

Normally, the number of transmits from which spatially related echo signals are combined, N_transmits, may be chosen from the group of; 2, 4, 8, 16, 32, 64, and 128. Advantageous results with low signal to noise ratio (SNR) have for example been obtained by the present inventors for N_transmits=4.

In some embodiments, the lens shape of the variable refractive lens may be varied for different transmit beams i.e. coarse steering of the imaging beam can be made feasible by the lens. Preferably, the variable refractive lens may be a fluid lens, preferably an electrowetting liquid lens.

In a second aspect, the present invention relates to an imaging system arranged for producing an ultrasound image, comprising: a variable refractive lens, and

an array of transducers for transmitting a plurality of transmit beams from, each transmit beam being centered at a different position along the array and each transmit beam encompassing a plurality of laterally spaced line positions which are spatially related to laterally spaced line positions of another beam, each transit beam being transmitted through the variable refractive lens with an associated lens shape;

the system being arranged for: receiving echo signals with the array of transducers, each echo signal being received through the variable refractive lens with an associated lens shape;

producing a plurality of receive lines of echo signals at the laterally spaced line positions of the receive beam by

concurrently processing the echo signals received in response to one transmit beam; or

repeatedly transmitting transmit events corresponding to the same transmit beam and for each receiving echo signals from a different direction,

repeating producing a plurality of receive lines of echo signals for additional transmit beams;

combining echo signals of receive lines from different transmit beams which are spatially related to produce image data; and

producing an image using the image data.

In a third aspect, the invention relates to a computer program product being adapted to enable a computer system comprising at least one computer having data storage means associated therewith to control an imaging system according to the third aspect of the invention.

This aspect of the invention is particularly, but not exclusively, advantageous in that the present invention may be implemented by a computer program product enabling a computer system to perform the operations of the second aspect of the invention. Thus, it is contemplated that some known imaging system may be changed to operate according to the present invention by installing a computer program product on a computer system controlling the said apparatus. Such a computer program product may be provided on any kind of computer readable medium, e.g. magnetically or optically based medium, or through a computer based network, e.g. the Internet.

The first, second and third aspect of the present invention may each be combined with any of the other aspects. These and other aspects of the invention will be apparent from and elucidated with reference to the embodiments described hereinafter.

### BRIEF DESCRIPTION OF THE FIGURES

The present invention will now be explained, by way of example only, with reference to the accompanying Figures, where

FIG. 1 is a schematic drawing of an imaging system with a variable refractive lens comprising an array of transducers according to the present invention,

FIGS. 2-4 are schematic drawings for illustrating the method for producing an ultrasonic image according to the present invention,

FIG. 5 is a graph showing the relative amplitude as a function of the relationship between array steering angle and grating lobe angle for the array of transducers,

FIG. 6 is schematic drawing illustrating the dynamic receive of echo signals according to the present invention, and

FIG. 7 is a flow chart of a method according to the invention.

### DETAILED DESCRIPTION OF EMBODIMENTS

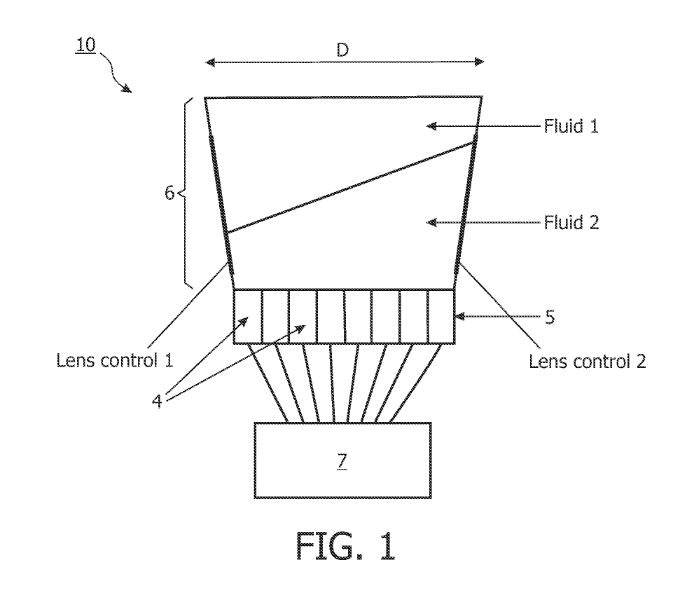

FIG. 1 is a schematic drawing of an imaging system 10 with a variable refractive lens 6 with a fluid 1 and a fluid 2. The lens is in this embodiment an electrowetting lens and further details and references about this lens can be found in “Apparatus for forming Variable Fluid Meniscus Configurations”, WO 20047051323 and WO 2008/0/4455 both to the same applicant. Both references being hereby incorporated by reference in its entirety. The lens 6 has appropriate voltage control as indicated on the sides of the lens 6.

Underneath the lens 6, an array 5 of transducers 4 is positioned. The lens 6 is used to effect coarse steering. It steers the transmit beam and remains pointing in the same direction during receive. Echoes arriving from on axis (and from the receive focal depth) will be well-aligned across the multi-element array. The signals on the array elements are received by the multi-channel receive beamformer 7. This will typically be a digital sampling beamformer. By altering the relative delay between the signals received on the different elements, it is possible for the receive beamformer to steer the receive beam away from the on-axis direction (as defined by the fluid focus lens). In addition, the receive beamformer 7 can effect dynamic receive focusing by varying the inter-element delay during the receive event. The beam former 7 is shown underneath the lens 6 but in a practical imaging system, e.g. a catheter, the beam former may be positioned distant from the lens 6. An appropriate beamformer 7 for implementing the present invention can be found in WO 2007/133878 to the same applicant. WO 2007/133878 is hereby incorporated by reference in its entirety.

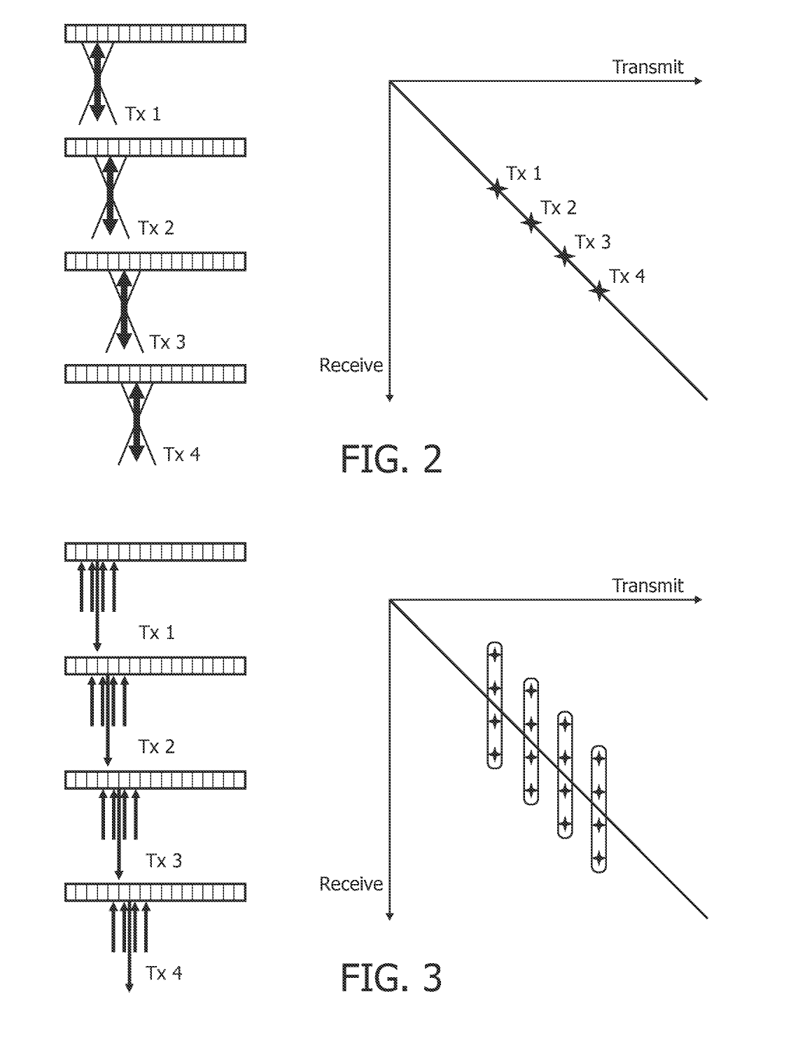

A conventional scanning process can be represented on a transmit-receive diagram as shown in FIG. 2. Transmit beams and receive beams are in the same direction. Both are translated by the same amount between successive image lines. This sequence is represented by the stars on the transmit-receive diagram (right), which lie along the line with slope −1. An image can be formed by transmitting and receiving beams with different angular directions, or (as shown) with different lateral offsets.

FIG. 3 is a transmit-receive diagram for acquisition according to the present invention using a 4× beamformer for illustrative purposes.

A multiline beamformer is capable of forming several receive lines for a single transmit

event. The different receive lines are formed by applying different sets of delays to the

same per-channel receive data. These receive lines correspond to receive beams that have different directions or different lateral offsets. With conventional imaging these multilines are usually used to increase the round-trip line density. For example, two receive beams can be used, one on either side of the transmit beam.

The spacing between receive beams is equal to the spacing between transmit beams. The receive beams for successive transmit events overlap by 3. The lines received from a given transmit event are enclosed in a box encircling the stars representing the echo signals.

With the present invention, the multilines are used in a special configuration. An example with a 4× multiline beamformer is shown in FIG. 3. The receive beams are parallel and spaced by an amount equal to the transmit spacing. The receive beams for successive transmits overlap by 3.

Consider the 4th (right-most) receive line for the first transmit. This receive line is also

formed for the other three transmits. This is highlighted by the horizontal encircling box in the transmit-receive diagram of FIG. 4. The present invention operates on the signals from these four transmit-receive events. Since the signals being combined correspond to the same receive beam, the combination may be said to happen in the transmit space. Thus, combining these echo signals of receive lines from different transmit beams, which are spatially related may be beneficially applied to produce image data according to the present invention.

In one embodiment, the data aquistion of the echo signals corresponding to a given transmit beam can be made from one transmit event, i.e. four echo signals are received. In another embodiment, a transmit event can give rise to the several echo signals but only one is received at first, and afterward a substantially identical transmit event occurs and another echo signal in a “column” (receive direction) of FIG. 3 or 4 is received. This is repeated to sequentially obtain the echo signals corresponding to the given transmit beam. This sequential acquisition may be beneficial for simplified processing.

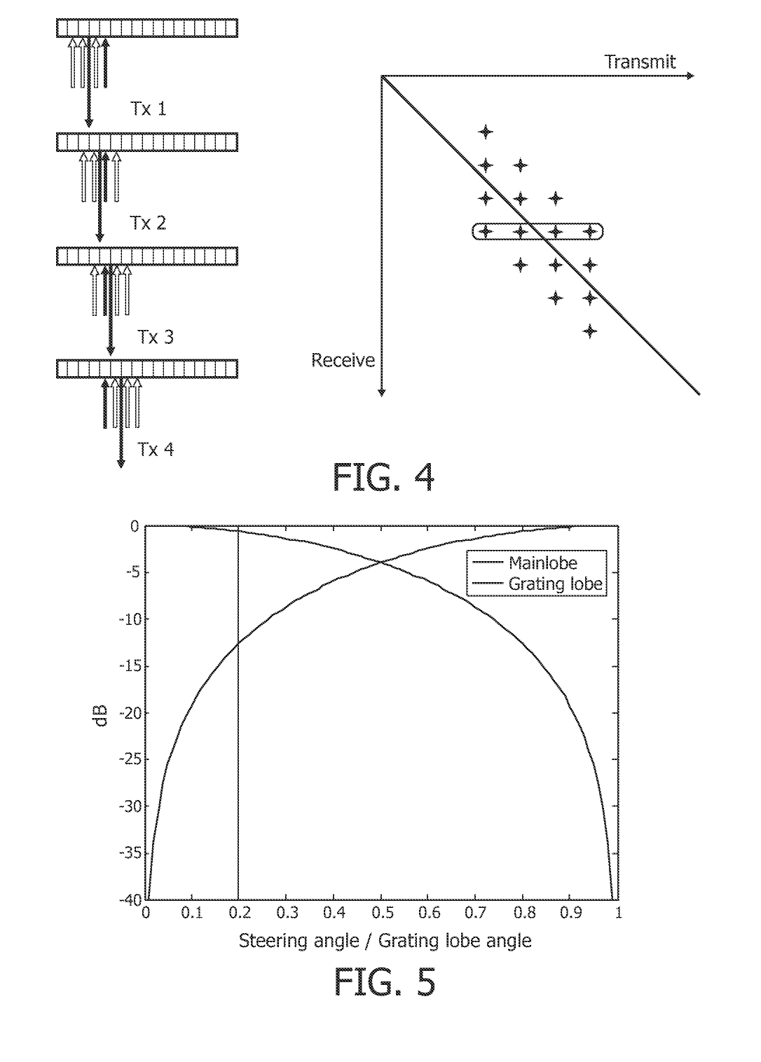

FIG. 5 is a graph showing the relative amplitude as a function of the relationship between array steering angle and grating lobe angle for an array of transducers i.e. the strength of main lobe and grating lobe for different steering angles. The x-axis is steering angle as a proportion of the grating lobe angle (=•/W (radians)). W is the width of the transducers. Zero angle corresponds to steering the receive in the same direction as the transmit. The value of 1 corresponds to steering the receive in the grating lobe direction. The vertical line shows the rule of thumb—steering angles less than 20% of the grating lobe angle are acceptable.

Taking the operating frequency as 25 MHz, which gives a wavelength • of 62 μm. Assuming that one wishes to perform the invention by combining 4 transmits spaced at the Nyquist spacing. This requires the multi-lines be spaced (a maximum) of (N_transmits−1)/2*•Tx from the transmit direction, where N_transmits is the number of combined transmits and •Tx is the angular transmit spacing. For N_transmits=4, maximum multi-line spacing=(4−1)/2*•Tx=3/2*•Tx.

If the transmits being combined are spaced at Nyquist, •Tx=•/D, where D is the transmit aperture. Therefore, max multi-line spacing=3/2*•/D. In order to meet the grating lobe requirements, it is required:

0.2*•/W>3/2*•/D

D/W>3/(2*0.2)=7.5

D/W is simply the number of array elements in the transmit array. Therefore, the number of elements should be larger than or equal to 8, N_elements•8.

If for example the aperture is 1.5 mm, then the element size or width required is 1.5/8=0.1875 mm. It is practicable to fabricate piezoelectric elements with this pitch using standard dicing methods.

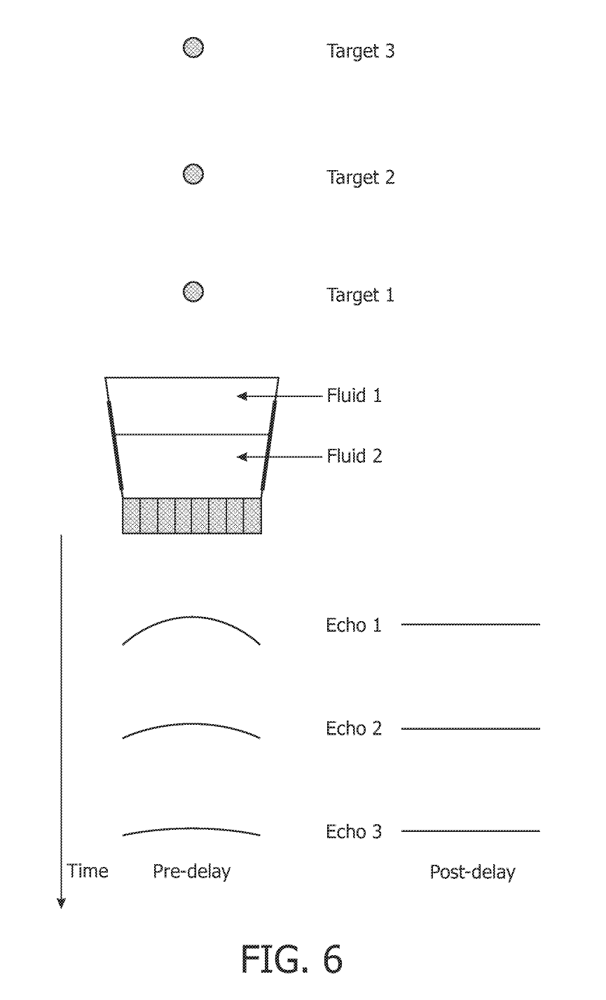

FIG. 6 is schematic drawing illustrating the dynamic receive of echo signals. Inertial effects limit the speed at which the fluid focus lens can be adjusted. This means that the receive focus is usually fixed. The current invention can be used to effect dynamic focusing by varying the inter-element delays over the time that the signals are being received. This is shown in FIG. 6 where wavefronts received from different depths within the medium containing the object have different curvatures. By varying the inter-element delay, the present invention may enable that the echoes are well-aligned no matter what depth they arrive from. The amounts of delay that are required are fairly small for this phased array configuration. For example, say that target1 is at a depth of 2 mm, then the distance between the target and the edge of the array is •(2²+0.75²)=2.136 mm, so that the difference in delay between the center of the array and the edge is 2.136−2=0.136 mm•2•. For target 3 at a depth of 10 mm (typically the maximum depth of interest), the difference is even smaller: •(10²+0.75²)=10.028 mm, so the difference in delay between the center and the edge is 0.028 mm •1/2•.

The current invention may also allow for dynamic apodization to be used. The receive aperture expands during the receive event: gradually more elements are added to the summation.

The present invention may further be applied for focusing the transmit beam. If the array elements are individually connected to transmitters, then the waveforms transmitted by each element can be phased or time shifted to effect transmit focusing.

The transmit can be focused or diverging. Transmit apodization is also possible.

The invention can also be implemented using an annular array of transducers. This permits the use of dynamic focusing and apodization on receive. It also permits the use of different fixed focal depths and apodizations on transmit.

The present invention can be used in the field of ultrasound imaging, in particular intra-cardiac catheter-based imaging. Such devices have been proposed for use in therapy monitoring for electrophysiology procedures for the treatment of atrial fibrillation.

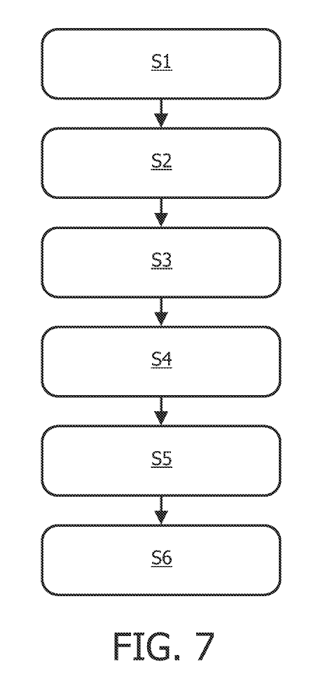

FIG. 7 is a flow chart of a method according to the invention for producing an ultrasound image with a variable refractive lens 6, cf. FIG. 1, comprising:

S1 transmitting a plurality of transmit beams, Tx1-Tx4, cf. FIGS. 2-4, from an array of transducers 5, each transmit beam being centered at a different position along the array and each transmit beam encompassing a plurality of laterally spaced line positions which are spatially related to laterally spaced line positions of another beam, each transit beam being transmitted through the variable refractive lens 6 with an associated lens shape;

S2 receiving echo signals with the array of transducers 5, each echo signal being received through the variable refractive lens 6 with an associated lens shape;

S3 producing a plurality of receive lines of echo signals at the laterally spaced line positions of the receive beam by

concurrently processing the echo signals received in response to one transmit beam; or repeatedly transmitting transmit events corresponding to the same transmit beam and for each receiving echo signals from a different direction,

S4 repeating producing a plurality of receive lines of echo signals for additional transmit beams;

S5 combining echo signals of receive lines from different transmit beams which are spatially related to produce image data; and

S6 producing an image using the image data

The invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A method for producing an ultrasound image with a variable refractive lens (6), comprising:
transmitting a plurality of transmit beams (Tx1-Tx4) from an array of transducers (5), each transmit beam being centered at a different position along the array and each transmit beam encompassing a plurality of laterally spaced line positions which are spatially related to laterally spaced line positions of another beam, each transit beam being transmitted through the variable refractive lens (6) with an associated lens shape;
receiving echo signals with the array of transducers (5), each echo signal being received through the variable refractive lens (6) with an associated lens shape;
producing a plurality of receive lines of echo signals at the laterally spaced line positions of the receive beam by
concurrently processing the echo signals received in response to one transmit beam; or
repeatedly transmitting transmit events corresponding to the same transmit beam and for each receiving echo signals from a different direction,
repeating producing a plurality of receive lines of echo signals for additional transmit beams;
combining echo signals of receive lines from different transmit beams which are spatially related to produce image data; and
producing an image using the image data.

2. The method according to claim 1, wherein at least a sub-group of transducers in the said array of transducers has a width, W, significantly larger than half the center wavelength of the transmit pulses.

3. The method according to claim 1, wherein the minimum number of transducers in the said array, N_elements, is given by the inequality;
N_elements=D/W>(N_transmits−1)/2*1/(M_{—}sa,gla)
where
D is the transmit aperture,
W is the width of each transducer at least in a sub-group of the transducers,
N_transmits is the number of transmits from which spatially related echo signals are combined, and
M_sa,gla is the maximum accepted relationship between steering angle and grating lobe angle of the refractive lens and the array of transducers.

4. The method according to claim 3, wherein the number of transducers in the array, N_elements, is above 5, 10, 15 or 20.

5. The method according to claim 3, wherein the transmit beam are ultrasonic high frequency pulses, preferably with center frequency of at least 20 MHz, 25 MHz, 30 MHz, 40 MHz or 50 MHz.

6. The method according to claim 3, wherein at least a sub-group of transducers, in the said array of transducers, have a width, W, above 0.1, 0.2 or 0.3 mm.

7. The method according to claim 3, wherein the maximum accepted relationship between steering angle and grating lobe angle, M, of the refractive lens and the array of transducers is in the interval of approximately 5-40%, preferably 10-35%, more preferably 15-25%.

8. The method according to claim 3, wherein the number of transmits from which spatially related echo signals are combined, N_transmits, is chosen from the group of; 2, 4, 8, 16, 32, 64, and 128.

9. The method according to claim 1, wherein the lens shape of the variable refractive lens is varied for different transmit beams.

10. The method according to claim 1, wherein the variable refractive lens is a fluid lens, preferably an electrowetting liquid lens.

11. An imaging system (10) arranged for producing an ultrasound image, comprising:
a variable refractive lens (6), and
an array of transducers (5) for transmitting a plurality of transmit beams (Tx1-Tx4) from, each transmit beam being centered at a different position along the array and each transmit beam encompassing a plurality of laterally spaced line positions which are spatially related to laterally spaced line positions of another beam, each transit beam being transmitted through the variable refractive lens (6) with an associated lens shape;
the system being arranged for:
receiving echo signals with the array of transducers (5), each echo signal being received through the variable refractive lens (6) with an associated lens shape;
producing a plurality of receive lines of echo signals at the laterally spaced line positions of the receive beam by
concurrently processing the echo signals received in response to one transmit beam; or
repeatedly transmitting transmit events corresponding to the same transmit beam and for each receiving echo signals from a different direction,
repeating producing a plurality of receive lines of echo signals for additional transmit beams;
combining echo signals of receive lines from different transmit beams which are spatially related to produce image data; and
producing an image using the image data.

12. A computer program product being adapted to enable a computer system comprising at least one computer having data storage means associated therewith to control an imaging system according to claim 11.
